(19) United States
(12) Patent Application Publication
(10) Pub. No.: US 2026/0253104 A1
(43) Pub. Date: Aug. 27, 2026

(54) SYSTEM AND METHOD FOR REWARD PREDICTING

(71) Applicant: Truist Bank, Charlotte, NC (US)

(72) Inventors: Himanshu Johri, Charlotte, NC (US); Rajendra Prasad Molakalapalli, Charlotte, NC (US); Abhay Vijay Mone, Charlotte, NC (US); Keyur Prakash Dave, Charlotte, NC (US)

(73) Assignee: Truist Bank, Charlotte, NC (US)

(21) Appl. No.: 19/066,031

(22) Filed: Feb. 27, 2025

(51) Int. Cl. G06Q 30/0251

(52) U.S. Cl. CPC G06Q 30/0255

(57) ABSTRACT

A system includes a display; a memory having stored therein, customer data associated with a customer, a plurality of promotion data relating to a respective plurality of available promotions, and executable instructions stored therein; and a processor configured to execute the executable instructions to cause the system to: generate a plurality of correlation values, each of which corresponds to a respective correlation between the customer data and each of the respective plurality of promotion data; identify an optimal available promotion based on a maximum correlation value of the plurality of correlation values; generate an available promotion signal based on the optimal available promotion; and transmit the available promotion signal to the display to cause the display to display information related to the optimal available promotion.

### TECHNICAL FIELD

Aspects of the present disclosure are generally related to systems and computer-implemented methods of identifying available credit card promotions.

### BACKGROUND

With respect to enterprises that issue payment cards such as credit cards to their customers, credit card promotions are special offers that may be used to encourage existing cardholders to use their cards more frequently. These promotions may encourage cardholders to use their cards more often, generating more transaction fees for the enterprise. As cardholders increase their spending to earn rewards, enterprises collect more fees from merchants for processing transactions. Further, credit card customers may be more likely to use other products and services of the enterprise, increasing overall revenue for the enterprise. By offering these promotions, enterprises aim to create long-term, profitable relationships with customers.

What is needed is a system and method to match customers with promotions that will optimize the customer's financial interest.

### SUMMARY

An aspect of the present disclosure is drawn to a system, including: a display; a memory having stored therein, customer data associated with a customer, a plurality of promotion data relating to a respective plurality of available promotions, and executable instructions stored therein; and a processor configured to execute the executable instructions to cause the system to: generate a plurality of correlation values, each of which corresponds to a respective correlation between the customer data and each of the respective plurality of promotion data; identify an optimal available promotion based on a maximum correlation value of the plurality of correlation values; generate an available promotion signal based on the optimal available promotion; and transmit the available promotion signal to the display to cause the display to display information related to the optimal available promotion.

In one or more embodiments of this aspect, the processor is further configured to execute the executable instructions to additionally cause the system to: identify a second available promotion based on a second correlation value of the plurality of correlation values; generate the available promotion signal based on optimal available promotion and the second available promotion; and transmit the available promotion signal to the display to cause the display to display information related to the optimal available promotion and the second available promotion.

In one or more embodiments of this aspect, the processor is further configured to execute the executable instructions to additionally cause the system to generate the plurality of correlation values using a machine learning algorithm. In one or more of these embodiments, the processor is further configured to execute the executable instructions to additionally cause the system to generate the plurality of correlation values using a neural network that has been trained via reinforcement learning as the machine learning algorithm. In one or more of these embodiments, the processor is further configured to execute the executable instructions to additionally cause the system to generate the plurality of correlation values using the neural network that has been trained via reinforcement learning to evaluate at least one of an address, a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the customer data.

In one or more embodiments of this aspect, the processor is further configured to execute the executable instructions to additionally cause the system to identify the optimal available promotion additionally based on a respective number of other customers associated with each of the respective plurality of promotion data.

In one or more embodiments of this aspect, the processor is further configured to execute the executable instructions to additionally cause the system to identify the optimal available promotion additionally based on a respective time associated with each of the respective plurality of promotion data.

Another aspect of the present disclosure is drawn to a computer-implemented method of operating a system. The computer-implemented method includes: generating, via a processor configured to execute executable instructions stored within a memory additionally having stored therein, customer data associated with a customer and a plurality of promotion data relating to a respective plurality of available promotions, a plurality of correlation values, each of which corresponds to a respective correlation between the customer data and each of the respective plurality of promotion data; identifying, via the processor, an optimal available promotion based on a maximum correlation value of the plurality of correlation values; generating, via the processor, an available promotion signal based on the optimal available promotion; and transmitting, via the processor and to a display, the available promotion signal to cause the display to display information related to the optimal available promotion.

In one or more embodiments of this aspect, the computer-implemented method further includes: identifying, via the processor, a second available promotion based on a second correlation value of the plurality of correlation values; generating, via the processor, the available promotion signal based on optimal available promotion and the second available promotion; and transmitting, via the processor and to the display, the available promotion signal to cause the display to display information related to the optimal available promotion and the second available promotion.

In one or more embodiments of this aspect, the generating the plurality of correlation values includes generating, via the processor, the plurality of correlation values using a machine learning algorithm. In one or more of these embodiments, the generating the plurality of correlation values using a machine learning algorithm includes generating, via the processor, the plurality of correlation values using a neural network that has been trained via reinforcement learning as the machine learning algorithm. In one or more of these embodiments, the generating the plurality of correlation values using a neural network that has been trained via reinforcement learning as the machine learning algorithms includes generating, via the processor, the plurality of correlation values using the neural network that has been trained via reinforcement learning to evaluate at least one of an address, a number of purchases tied, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the customer data.

In one or more embodiments of this aspect, the identifying the optimal available promotion includes identifying, via the processor, the optimal available promotion additionally based on a respective number of other customers associated with each of the respective plurality of promotion data.

In one or more embodiments of this aspect, the identifying the optimal available promotion includes identifying, via the processor, the optimal available promotion additionally based on a respective time associated with each of the respective plurality of promotion data.

Another aspect of the present disclosure is drawn to a non-transitory, computer-readable media having computer-readable instructions stored thereon, wherein the computer-readable instructions are capable of being read by system, and wherein the computer-readable instructions are capable of instructing the system to perform a computer-implemented method including: generating, via a processor configured to execute executable instructions stored within a memory additionally having stored therein, customer data associated with a customer and a plurality of promotion data relating to a respective plurality of available promotions, a plurality of correlation values, each of which corresponds to a respective correlation between the customer data and each of the respective plurality of promotion data; identifying, via the processor, an optimal available promotion based on a maximum correlation value of the plurality of correlation values; generating, via the processor, an available promotion signal based on the optimal available promotion; and transmitting, via the processor and to a display, the available promotion signal to cause the display to display information related to the optimal available promotion.

In one or more embodiments of this aspect, the computer-readable instructions are capable of instructing the system to perform the computer-implemented method further including: identifying, via the processor, a second available promotion based on a second correlation of the plurality of correlation values; generating, via the processor, the available promotion signal based on optimal available promotion and the second available promotion; and transmitting, via the processor and to the display, the available promotion signal to cause the display to display information related to the optimal available promotion and the second available promotion.

In one or more embodiments of this aspect, the computer-readable instructions are capable of instructing the system to perform the computer-implemented method wherein the generating the plurality of correlation values includes generating, via the processor, the plurality of correlation values using a machine learning algorithm. In one or more of these embodiments, the computer-readable instructions can instruct the system to perform the computer-implemented method wherein the generating the plurality of correlation values using a machine learning algorithm includes generating, via the processor, the plurality of correlation values using a neural network that has been trained via reinforcement learning as the machine learning algorithm. In one or more of these embodiments, the computer-readable instructions are capable of instructing the system to perform the computer-implemented method wherein the generating the plurality of correlation values using the neural network that has been trained via reinforcement learning includes generating, via the processor, the plurality of correlation values using the neural network that has been trained via reinforcement learning to evaluate at least one of an address, a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the customer data.

In one or more embodiments of this aspect, the computer-readable instructions are capable of instructing the system to perform the computer-implemented method wherein the identifying the optimal available promotion includes identifying, via the processor, the optimal available promotion additionally based on at least one of a respective number of other customers associated with each of the respective plurality of promotion data and a respective time associated with each of the respective plurality of promotion data.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein.

FIG. 2 illustrates a block diagram of the client device of FIG. 1.

FIG. 3 illustrates a block diagram of the one or more servers of FIG. 1.

FIG. 4 illustrates a block diagram of the data stores of the one or more servers of FIG. 3.

FIG. 5 illustrates an example computer-implemented method of matching customers to respective optimal promotions in accordance with aspects of the present disclosure.

FIG. 6 illustrates a block diagram of an example business entity having the one or more servers of FIG. 1.

FIG. 7 illustrates a block diagram of an example enterprise user device of FIG. 6.

FIG. 8 illustrates a block diagram of a portion of one or more enterprise servers of FIG. 3 for classifying a customer as viable or non-viable in accordance with aspects of the present disclosure.

FIG. 9A illustrates a block diagram of a portion of one or more enterprise servers of FIG. 3 for determining a correlation between a customer's purchase history and an available promotion at a time t₀ in accordance with aspects of the present disclosure.

FIG. 9B illustrates a block diagram of a portion of one or more enterprise servers of FIG. 3 for determining a correlation between a customer's purchase history and another available promotion at a time t₁ in accordance with aspects of the present disclosure.

FIG. 9C illustrates a block diagram of a portion of one or more enterprise servers of FIG. 3 for determining a correlation between a customer's address and an available promotion at a time t₂ in accordance with aspects of the present disclosure.

FIG. 9D illustrates a block diagram of a portion of one or more enterprise servers of FIG. 3 for determining a correlation between a customer's address and another available promotion at a time t₃ in accordance with aspects of the present disclosure.

FIG. 9E illustrates a block diagram of a portion of one or more enterprise servers of FIG. 3 for determining a correlation between a customer's purchase history and a customer's address and an available promotion at a time t₄ in accordance with aspects of the present disclosure.

FIG. 9F illustrates a block diagram of a portion of one or more enterprise servers of FIG. 3 for determining a correlation between a customer's purchase history and the customer's address with another available promotion at a time t₅ in accordance with aspects of the present disclosure.

FIG. 10 illustrates the promotions data storage displaying available promotions in accordance with aspects of the present disclosure.

FIG. 11 illustrates a plot of example calculated Pearson correlation coefficients between an example customer data of an example viable customer of an enterprise with ten different available promotions.

FIG. 12A illustrates a block diagram of a portion of one or more enterprise servers of FIG. 3 for determining a correlation between a customer's purchase history and another customer's purchase history that is currently using an available promotion at a time t₆ in accordance with aspects of the present disclosure.

FIG. 12B illustrates a block diagram of a portion of one or more enterprise servers of FIG. 3 for determining a correlation between a customer's purchase history and another customer's purchase history that is currently using another available promotion at a time t₉ in accordance with aspects of the present disclosure.

FIG. 12C illustrates a block diagram of a portion of one or more enterprise servers of FIG. 3 for determining a correlation between a customer's purchase history and yet another customer's purchase history that is currently using an available promotion at a time t₈ in accordance with aspects of the present disclosure.

FIG. 12D illustrates a block diagram of a portion of one or more enterprise servers of FIG. 3 for determining a correlation between a customer's purchase history and another customer's purchase history that is currently using another available promotion at a time t₉ in accordance with aspects of the present disclosure.

FIG. 13A illustrates a block diagram of a portion of one or more enterprise servers of FIG. 3 for determining a correlation between a customer's purchase history and an available promotion at a time t₈ in accordance with aspects of the present disclosure.

FIG. 13B illustrates a block diagram of a portion of one or more enterprise servers of FIG. 3 for determining a correlation between another customer's purchase history and another available promotion at a time t₉ in accordance with aspects of the present disclosure.

FIG. 14 illustrates a block diagram of a portion of one or more enterprise servers of FIG. 3 for determining a correlation using a combination of the embodiments discussed in FIGS. 12A-13B in accordance with aspects of the present disclosure.

FIG. 15 illustrates a block diagram of a portion of one or more enterprise servers of FIG. 3 for identifying an optimal promotion in accordance with aspects of the present disclosure.

FIG. 16 illustrates a block diagram of a portion of one or more enterprise servers of FIG. 3 for identifying whether a customer is currently using an available promotion in accordance with aspects of the present disclosure.

FIG. 17 illustrates a block diagram of a portion of one or more enterprise servers of FIG. 3 for identifying whether a customer's currently used promotion is the optimal available promotion.

FIG. 18A illustrates a block diagram of a portion of one or more enterprise servers of FIG. 3 and the enterprise user device of FIG. 6 for displaying information related to acknowledging a currently used promotion in accordance with aspects of the present disclosure.

FIG. 18B illustrates a block diagram of a portion of one or more enterprise servers of FIG. 3 and the enterprise user device of FIG. 6 for displaying information related to informing of an alternate promotion in accordance with aspects of the present disclosure.

FIG. 18C illustrates a block diagram of a portion of one or more enterprise servers of FIG. 3 and the enterprise user device of FIG. 6 for displaying information related to informing of a promotion in accordance with aspects of the present disclosure.

FIG. 19A illustrates a user interface of the enterprise user device of FIG. 7 displaying an acknowledge promotion message in accordance with aspects of the present disclosure.

FIG. 19B illustrates a user interface of the enterprise user device of FIG. 7 displaying an alternate promotion message in accordance with aspects of the present disclosure.

FIG. 19C illustrates a user interface of the enterprise user device of FIG. 7 displaying a promotion message in accordance with aspects of the present disclosure.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “dynamically” relates to customer engagement events or actions that can be caused, triggered, or otherwise occur without human intervention.

As used herein, “machine learning” relates to an application of AI that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module includes a general-purpose processor configured by software to become a special-purpose processor, the general-purpose processor may be configured as respectively different special-purpose processors (e.g., including different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a computer-implemented method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

As used herein, “widget” relates to electronic visual tiles that may be added to a home screen dashboard that are bigger than a regular application icon and have additional functionality. The widget may include shortcuts directly to popular features within an enterprise application.

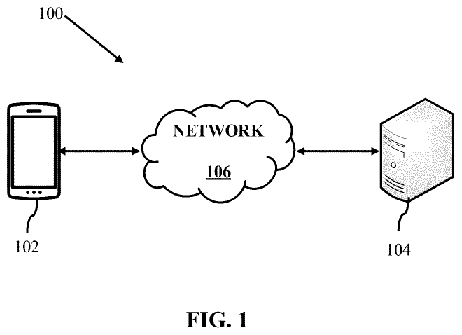

Turning to the figures, in which FIG. 1 illustrates a communication environment 100 in which a user communicates with an enterprise. A client device 102 operating in communication environment 100 facilitates user access to and user management of one or more user accounts residing at one or more enterprise servers 104. Communication environment 100 includes client device 102, one or more enterprise servers 104, and a communications network 106 through which communication is facilitated between client device 102 and one or more enterprise servers 104.

In accordance with one or more embodiments, client device 102 may take the form of a computing device, non-limiting examples of which include a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates client device 102 including any form of electronic device that optimizes the performance and functionality of the one or more embodiments in a manner that falls within the spirit and scope of the principles of this disclosure.

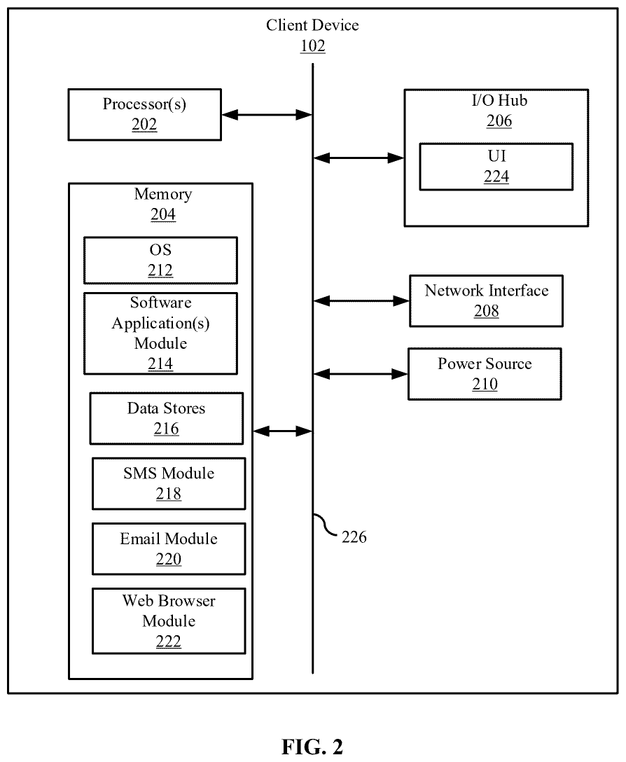

FIG. 2 illustrates a block diagram of client device 102. It will be understood that it is not necessary for client device 102 to have all the elements illustrated in FIG. 2. For example, client device 102 may have any combination of the various elements illustrated in FIG. 2. Moreover, client device 102 may have additional elements to those illustrated in FIG. 2.

As shown in the figure, client device 102 includes one or more processors 202, a non-transitory memory 204 operatively coupled to one or more processors 202, an input/output (I/O) hub 206, a network interface 208, a power source 210, and a communication bus 226.

In this example, one or more processors 202, non-transitory memory 204, I/O hub 206, network interface 208, and power source 210 are illustrated as individual elements of client device 102. However, in one or more embodiments, at least two of one or more processors 202, non-transitory memory 204, I/O hub 206, network interface 208, and power source 210 may be combined as a unitary device. Further, in one or more embodiments, at least one of one or more processors 202, non-transitory memory 204, I/O hub 206, and network interface 208 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to client device 102 such that the processor may read information from and write information to the tangible computer-readable media. In the alternative, the tangible computer-readable media may be integral to client device 102. The tangible computer-readable media may reside in an integrated circuit (IC), an ASIC, or large-scale integrated circuit (LSI), system LSI, super LSI, or ultra LSI components that perform a part or all of the functions described herein. In the alternative, the tangible computer-readable media may reside as discrete components.

Example tangible computer-readable media may be also coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

In the figure, one or more processors 202, non-transitory memory 204, I/O hub 206, network interface 208, and power source 210 are configured to communicate with one another via communication bus 226.

Memory 204 includes a set of instructions of computer-executable program code, an operating system 212, a software application module 214, one or more data stores 216, a short message service (SMS) module 218, an email module 220, and a web browser module 222.

In this example, operating system 212, software application module 214, one or more data stores 216, SMS module 218, email module 220, and web browser module 222 are illustrated as individual elements of memory 204. However, in one or more embodiments, at least two of operating system 212, software application module 214, one or more data stores 216, SMS module 218, email module 220, and web browser module 222 may be combined as a unitary element.

The set of instructions within memory 204 are executable by one or more processors 202 to cause one or more processors 202 to execute operating system 212 and one or more software applications of software application module 214 that reside in memory 204. The one or more software applications residing in memory 204 includes, but is not limited to, an enterprise application that is associated with the one or more enterprise servers 104 and which facilitates user access to the one or more user accounts in addition to user management of the one or more user accounts. The enterprise application includes a mobile application that facilitates establishment of a secure connection between client device 102 and one or more enterprise servers 104.

One or more data stores 216 are operable to store one or more types of data. Client device 102 may include one or more interfaces that facilitate one or more systems or modules thereof to transform, manage, retrieve, modify, add, or delete, the data residing in one or more data stores 216. One or more data stores 216 may include volatile and/or non-volatile memory. Examples of suitable data stores 216 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. One or more data stores 216 may be a component of one or more processors 202, or alternatively, may be operatively connected to one or more processors 202 for use thereby. As set forth, described, and/or illustrated herein, “operatively connected” may include direct or indirect connections, including connections without direct physical contact.

SMS module 218 is operable to facilitate user transmission and receipt of text messages via client device 102 though network 106. In one example embodiment, a user may receive text messages from the enterprise that are associated with the user access and the user management of the one or more user accounts.

Email module 220 is operable to facilitate user transmission and receipt of email messages via client device 102 through network 106. In one example embodiment, a user may receive email messages from the enterprise that are associated with the user access and the user management of the one or more user accounts.

Web browser module 222 is operable to facilitate user access to one or more websites associated with the enterprise through network 106.

I/O hub 206 is operable to connect to other systems and subsystems of client device 102. I/O hub 206 may include one or more of an input interface, an output interface, and a network controller to facilitate communications between client device 102 and one or more enterprise servers 104. The input interface and the output interface may be integrated as a single, unitary user interface 224, or alternatively, be separate as independent interfaces that are operatively connected.

As used herein, the input interface is defined as any device, software, component, system, element, or arrangement or groups thereof that enable information and/or data to be entered as input commands by a user in a manner that directs one or more processors 202 to execute instructions. The input interface may include a user interface (UI), a graphical user interface (GUI), such as, for example, a display, human-machine interface (HMI), or the like. Embodiments, however, are not limited thereto, and thus, this disclosure contemplates the input interface including a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may include one or more of a visual display or an audio display, including, but not limited to, a microphone, earphone, and/or speaker. One or more components of client device 102 may serve as both a component of the input interface and a component of the output interface.

Network interface 208 is operable to facilitate connection to network 106.

Power source 210 includes at least one of a wired powered source, a wireless power source, a replaceable battery source, a rechargeable battery source, and combinations thereof.

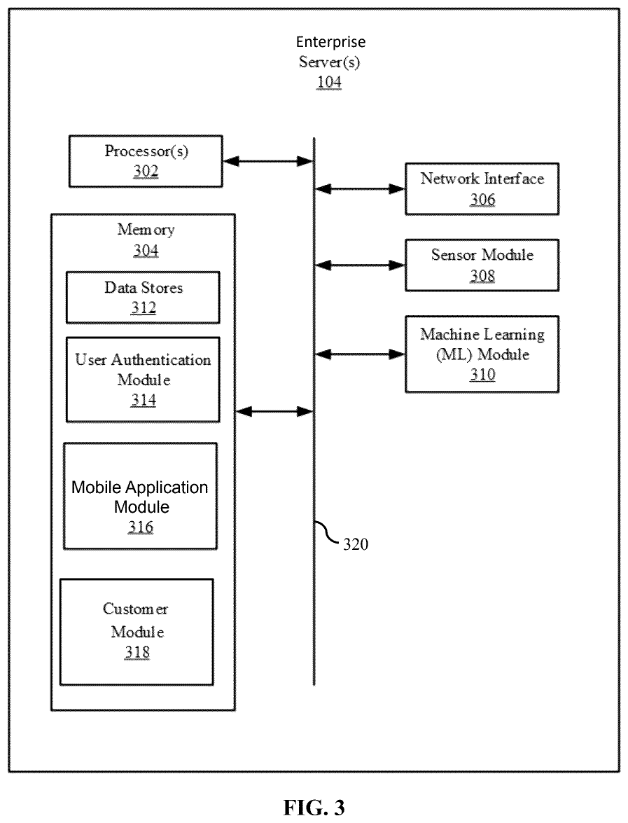

FIG. 3 illustrates a block diagram of one or more enterprise servers 104. It will be understood that it is not necessary for each server in one or more enterprise servers 104 to have all the elements illustrated in FIG. 3. For example, each server in one or more enterprise servers 104 may have any combination of the various elements illustrated in FIG. 3. Moreover, each server in one or more enterprise servers 104 may have additional elements to those illustrated in FIG. 3.

As illustrated in FIG. 3, one or more enterprise servers 104 includes one or more processors 302, a non-transitory memory 304 operatively coupled to one or more processors 302, a network interface 306, a sensor module 308, a machine learning (ML) module 310, and a communication bus 320.

In this example, one or more processors 302, non-transitory memory 304, network interface 306, sensor module 308, and ML module 310 are illustrated as individual elements of one or more enterprise servers 104. However, in one or more embodiments, at least two of one or more processors 302, non-transitory memory 304, network interface 306, sensor module 308, and ML module 310 may be combined as a unitary device. Further, in one or more embodiments, at least one of one or more processors 302, non-transitory memory 304, network interface 306, sensor module 308, and ML module 310 may be implemented as a computer having non-transitory computer-readable media for carrying or having computer-executable instructions or data structures stored thereon.

In the figure, one or more processors 302, non-transitory memory 304, network interface 306, sensor module 308, and ML module 310 are configured to communicate with one another via communication bus 226.

Memory 304 includes a set of instructions of computer-executable program code, one or more data stores 312, a user authentication module 218, and a mobile application module 316.

In this example, one or more data stores 312, a user authentication module 218, and a mobile application module 316 are illustrated as individual elements of memory 304. However, in one or more embodiments, at least two of one or more data stores 312, a user authentication module 218, and a mobile application module 316 may be combined as a unitary element.

The set of instructions in memory 304 are executable by one or more processors 302 in manner that facilitates control of a user authentication module 314 and a mobile application module 316 having one or more mobile applications that reside in memory 304.

One or more data stores 312 are operable to store one or more types of data, including but not limited to, user account data and user authentication data. One or more data stores 312 may include volatile and/or non-volatile memory. Examples of suitable data stores 312 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. One or more data stores 312 may be a component of one or more processors 302, or alternatively, may be operatively connected to one or more processors 302 for use thereby. As set forth, described, and/or illustrated herein, “operatively connected” may include direct or indirect connections, including connections without direct physical contact.

The computer-executable program code may instruct one or more processors 302 to cause user authentication module 312 to authenticate a user in order to gain user access to the one or more user accounts. User authentication module 312 may be caused to request user input user data or user identification that include, but are not limited to, user identity (e.g., user name), a user passcode, a cookie, user biometric data, a private key, a token, and/or another suitable authentication data or information.

The computer-executable program code of the one or more mobile applications of mobile application module 316 may instruct one or more processors 302 to execute certain logic, data-processing, and data-storing functions of one or more enterprise servers 104, in addition to certain communication functions of one or more enterprise servers 104. The one or more mobile applications of mobile application module 316 are operable to communicate with client device 102 in a manner which facilitates user access to the one or more user accounts in addition to user management of the one or more user accounts based on successful user authentication.

In accordance with one or more embodiments set forth, described, and/or illustrated herein, network 106 may include a wireless network, a wired network, or any suitable combination thereof. For example, network 106 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

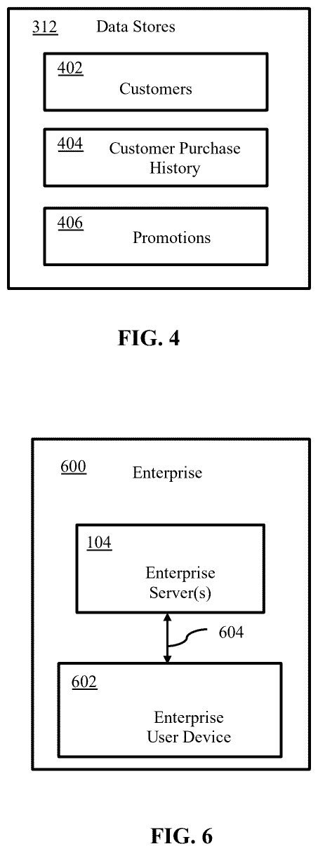

FIG. 4 illustrates a block diagram of data stores 312. As shown in the figure, data stores 312 includes a customer data storage 402, a customer purchase history data storage 404, and a promotions data storage 406.

Customer data storage 402 may be configured to store data associated with each individual customer, non-limiting examples of which include: customer name; customer address; customer phone number(s); customer email address(es); customer start date; customer payment history; customer account limit; and customer account number.

Customer purchase history data storage 404 may be configured to store data associated with purchase history for each individual customer, non-limiting examples of which include: purchase dates; purchase amounts; and purchase locations.

Promotions data storage 406 may be configured to store data associated with promotions provided by the institution, non-limiting examples of which include a promotion title, an introductory rate, an introductory time window, a standard rate, a transfer rate, a change in credit limit, cash-back reward amount, cash-back reward requirement, travel points reward amount, travel points reward requirement, and combinations thereof.

Although an enterprise may offer promotions associated with a credit card, the enterprise is not legally permitted to automatically implement a promotion, even in cases where it would be beneficial to the credit card holder. For example, consider an example scenario wherein a credit card customer makes multiple purchases weekly at a local restaurant using the credit card. Further, consider in this example scenario that the enterprise has an available promotion for a cash-back for every purchase at the restaurant. Even though in this scenario, the credit card customer would benefit by using the available promotion, without any drawbacks, the enterprise is not permitted to automatically implement the cash-back promotion related to the restaurant for the credit card of the customer. Unfortunately, the enterprise can only implement the when the customer actively requests to use the promotion for the customer's credit card.

To further complicate matters, an enterprise may provide a plurality of promotions for credit card customers, wherein each promotion has distinct respective parameters, such as an introductory rate, an introductory time window, a standard rate, a transfer rate, a change in credit limit, cash-back reward amount, cash-back reward requirement, travel points reward amount, travel points reward requirement, and combinations thereof. Therefore, identifying a promotion that would best benefit any particular customer is complicated. Additionally, a customer might not be inclined to listen to a description of each available promotion to determine which promotion they would like to implement with their credit card.

In accordance with aspects of the present disclosure, a computer-implemented method matches an optimal available promotion for a credit card from an enterprise with a customer. In this manner, when the customer communicates with an employee of the enterprise, a user device of the employee may populate with information related to the optimal available promotion for the credit card of the customer. In this manner, the customer may be easily informed of the optimal available promotion, without having to listen to a discussion of each available promotion. This minimized discussion, focused on the optimal available promotion will likely increase the likelihood of the customer implementing the optimal available promotion. Implementation and use of the optimal available promotion, would likely increase the customer's spending to earn rewards, which would increase the fees collected by the enterprise. Further, the credit card customer may be more likely to use other products and services, increasing overall revenue for the enterprise, and strengthening the long-term, profitable relationship between the enterprise and the customer.

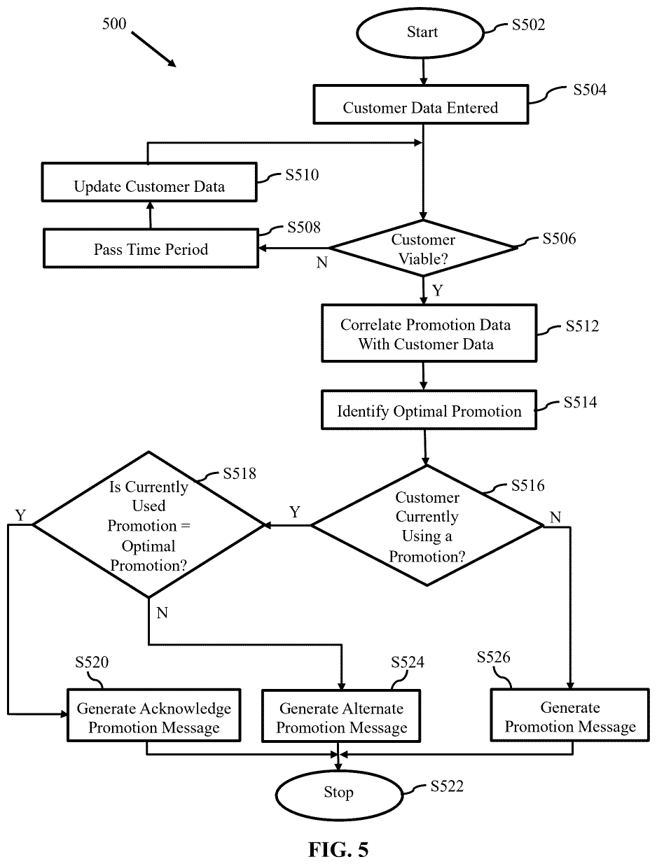

FIG. 5 illustrates an example computer-implemented method 500 of matching customers to respective optimal promotions in accordance with aspects of the present disclosure.

As shown in the figure, computer-implemented method 500 starts (S502) and customer data is entered (S504). For example, returning to FIG. 3, one or more processors 302 may execute instructions in customer module 318 to cause one or more processors 302 enter customer data into data stores 312. As shown in FIG. 4, when a customer joins the enterprise. This will be described in greater detail with reference to FIGS. 6-7.

FIG. 6 illustrates a block diagram of an example enterprise 600 having one or more enterprise servers 104. As shown in the figure, enterprise 600 includes one or more enterprise servers 104, an enterprise user device 602, and a communication channel 604.

One or more enterprise servers 104 are configured to communicate with enterprise user device 602 via communication channel 604.

Enterprise user device 602 may be any device or system that is configured to enable a user to access and interact with one or more enterprise servers 104. Non-limiting examples of enterprise user device 602 include a computer or client device.

FIG. 7 illustrates a block diagram of enterprise user device 602. As shown in the figure, enterprise user device 602 includes a system controller 702, a memory 704 having instructions and a customer program 706 stored therein, an input/output (I/O) interface module 708, a communication module 710, a user interface (UI) 712, and communication channels 714, 716, 718, and 720.

In this example, system controller 702, memory 704, I/O interface module 708, communication module 710, and UI 712 are illustrated as individual elements of one or more enterprise user device 602. However, in one or more embodiments, at least two of system controller 702, memory 704, I/O interface module 708, communication module 710, and UI 712 may be combined as a unitary device. Further, in one or more embodiments, at least one of system controller 702, memory 704, I/O interface module 708, communication module 710, and UI 712 may be implemented as a computer having non-transitory computer-readable media for carrying or having computer-executable instructions or data structures stored thereon.

System controller is configured to communicate with: memory 704 via communication channel 714; I/O interface module 708 via communication channel 716; communication module 710 via communication channel 718; and UI 712 via communication channel 712.

I/O interface module is additionally configured to communicate with one or more enterprise servers 104 via communication channel 604.

Communication module is additionally configured to communicate with client device 102 via communication channel 722 and network 106.

Each of communication channels 714, 716, 718, 720, and 722 may be any known type of communication channel, including wired and wireless.

System controller 702 may be any device or system that is configured to control general operations of enterprise user device 602 and includes, but is not limited to, a CPU, a hardware microprocessor, a single core processor, a multi-core processor, an FPGA, a microcontroller, an ASIC, a DSP, or other similar processing device capable of executing any type of instructions, algorithms, or software for controlling the operation and functions of enterprise user device 602.

Memory 704 may be any device or system capable of storing data and instructions used by enterprise user device 602 and includes, but is not limited to, RAM, DRAM, a hard drive, a solid-state drive, ROM, EPROM, EEPROM, flash memory, embedded memory blocks in an FPGA, or any other various layers of memory hierarchy.

Customer program 706 includes instructions, that when executed by system controller 702, enable enterprise user device 602 to perform the functions disclosed herein.

In one or more embodiments, as will be described in greater detail below, customer program 706 includes instructions, that when executed by system controller 702, enable enterprise user device 602 to cause UI 712 to display information related to acknowledgment of a customer's current implemented promotion.

In one or more embodiments, as will be described in greater detail below, customer program 706 includes instructions, that when executed by system controller 702, enable enterprise user device 602 to cause UI 712 to display information related to an alternate available promotion for a customer.

In one or more embodiments, as will be described in greater detail below, customer program 706 includes instructions, that when executed by system controller 702, enable enterprise user device 602 to cause UI 712 to display information related to an optimal available promotion for a customer.

I/O interface module 708 is operable to connect to one or more enterprise servers 104. I/O interface module 708 may include one or more of an input interface, an output interface, and a network controller to facilitate communications between enterprise user device 602 and one or more enterprise servers 104. The input interface and the output interface may be integrated as a single, unitary interface, or alternatively, be separate as independent interfaces that are operatively connected.

Communication module 710 may be any device or system that is operable to facilitate user communications with devices external to enterprise 600. In one or more embodiments, communication module is operable to enable transmission of text messages from enterprise user device 602 to client device 102 though network 106 via communication channel 722. In one or more embodiments, communication module 710 is operable to enable receipt of text messages from client device 102 by enterprise user device 602 though network 106 via communication channel 722. In one or more embodiments, communication module is operable to enable transmission of email messages from enterprise user device 602 to client device 102 though network 106 via communication channel 722. In one or more embodiments, communication module 710 is operable to enable receipt of email messages from client device 102 by enterprise user device 602 though network 106 via communication channel 722. In one or more embodiments, communication module is configured to facilitate user access to one or more websites through network 106.

UI 712 may be any device, software, component, system, element, or arrangement or groups thereof that enable information and/or data to be entered as input commands by a user in a manner that directs system controller 702 to execute instructions and that enable information/data to be presented to a user. UI 712 may include a user interface (UI), a graphical user interface (GUI), such as, for example, a display, human-machine interface (HMI), or the like. Embodiments, however, are not limited thereto, and thus, this disclosure contemplates UI 712 including a keypad, touch screen, multi-touch screen, button, joystick, mouse, trackball, microphone and/or combinations thereof. UI 712 may additionally include one or more of a visual display or an audio display, including, but not limited to, a microphone, earphone, and/or speaker.

In operation, when a customer joins enterprise 600 a stakeholder (e.g., employees, board members, etc.) (not shown) of enterprise may enter data associated with the customer into one or more enterprise servers 104. Specifically, the employee may enter data associated with the customer via user interface 712. System controller 702 will execute instructions in customer grogram 706 to cause I/O interface module 708 to store the data associated with the customer into customer data storage 402. Non-limiting examples of the types of data associated with the customer include customer name; customer address; customer phone number(s); customer email address(es); and customer start date.

In one or more embodiments, customer program 706 includes instructions, that when executed by system controller 702, cause system controller 702 to generate a customer account limit and a customer account number, and store the generated customer account limit and customer account number into customer data storage 402.

Returning to FIG. 5, after customer data is entered (S504), it is determined whether the customer is viable (S506). For example, returning to FIG. 3, one or more processors 302 may execute instructions in customer module 318 to cause one or more enterprise servers 104 to determine whether the customer is viable.

In accordance with aspects of the present disclosure, a customer is viable when the period that the customer has been a customer of enterprise 600 is equal to or greater than a time threshold T_{TH}.

In one or more embodiments, the time threshold T_{TH} may be further limited to exclude customers that have breached terms of enterprise 600. For example, in one or more embodiments, a customer is viable: if the customer has been a customer of enterprise 600 for longer than a predetermined threshold of time T_{TH}; and if the customer has breached any terms of enterprise 600 for more than a predetermined threshold of time T_{BT}. In one or more embodiments, T_{TH} is equal to or greater than two years. A non-limiting type of breach of terms includes making late payments. In one or more embodiments, T_{BT} is equal to or greater than two years. In one or more embodiments, T_{TH} and T_{BT} are different threshold values. In one or more embodiments, T_{TH} and T_{BT} are the saved threshold values.

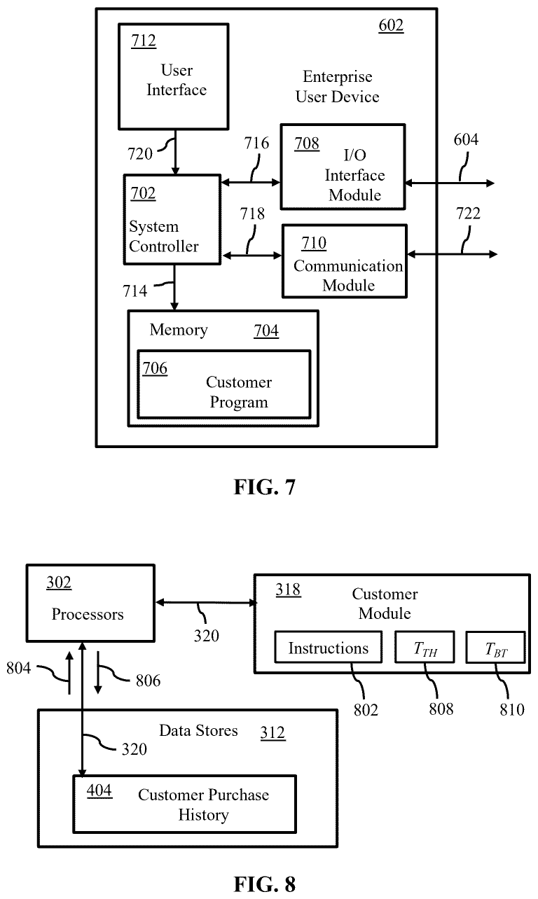

FIG. 8 illustrates a block diagram of one or more processors 302, customer purchase history storage 404 within data stores 312 and customer module 318 for classifying a customer as viable or non-viable in accordance with aspects of the present disclosure. Customer module 318 includes instructions 802, the value of the predetermined threshold of time T_{TH} indicated as data item 808, and the value of the predetermined threshold of time T_{BT} indicated as data item 810, stored therein.

In one or more embodiments, one or more processors 302 may execute instructions 802 in customer module 318 to cause one or more enterprise servers 104 to store the values of T_{TH} and T_{BT} in customer module 318. In one or more embodiments, one or more processors 302 may execute instructions in customer module 318 to cause one or more enterprise servers 104 to modify the values of at least one of T_{TH} and T_{BT}.

In operation, when evaluating a customer as being viable or non-viable, one or more processors 302 execute instructions 802 to cause one or more processors to obtain data 804 from customer purchase history data storage 404, wherein the data indicates how long the customer has been a customer and dates of any breaches of terms by the customer. One or more processors 302 then execute instructions 802 to cause one or more processors to compare data 804 with data item 808 and data item 810 to determine whether the customer is viable or non-viable. One or more processors 302 then execute instructions 802 to cause one or more processors to send a classification instruction 806 to modify the customer data within customer purchase history so as to label the customer as viable or non-viable.

As mentioned above, an aspect of the present disclosure is to match customers with promotions that will optimize the customer's financial interest. However, enterprise 600 may not be willing to offer such promotions to customers who are relatively new, or have missed or made late payments in the recent past. For this reason, enterprise 600 may filter or weed out such customers to create a pool of “viable” customers, or those that would more likely provide a benefit to enterprise 600 with a new promotion.

Returning to FIG. 5, if it is determined that the customer is not viable (N at S506), then a time period passes (S508). For example, returning to FIG. 3, one or more processors 302 may execute instructions in customer module 318 to cause one or more enterprise servers 104 to wait a predetermined period of time T_{W}.

Although a customer may not have been a customer sufficiently long to surpass T_{TH}, as discussed above, that time period will eventually change. For this reason, it is beneficial to repeatedly check the status of customers to increase the pool of viable customers. Similarly, a customer may have had a breech in at least one term of enterprise 600 that is within the predetermined threshold of time T_{BT}. However, if that customer does not commit any further breaches, they will sufficiently pass the predetermined threshold of time T_{BT}.

In one or more embodiments, one or more processors 302 may execute instructions in customer module 318 to cause one or more enterprise servers 104 to store the value of T_{W} in customer module 318. In one or more embodiments, one or more processors 302 may execute instructions in customer module 318 to cause one or more enterprise servers 104 to modify the value of T_{W}.

Returning to FIG. 5, after a time period passes (S508), customer data is updated (S510). For example, returning to FIGS. 3 and 4, one or more processors 302 may execute instructions in customer module 318 to cause one or more enterprise servers 104 to update customer data in customer data storage 402.

In one or more embodiments, one or more processors 302 may execute instructions in customer module 318 to cause one or more enterprise servers 104 to update the time for which each customer has been a customer in customer data storage 402. Further, in one or more embodiments, one or more processors 302 may execute instructions in customer module 318 to cause one or more enterprise servers 104 to update the time for which each customer has breached at least one term of enterprise 600. With this in mind, in one or more embodiments, one or more processors 302 may execute instructions in customer module 318 to cause one or more enterprise servers 104 to additionally update customer data for any customer that has breached at least one term of enterprise 600 within predetermined time period T_{W}.

Returning to FIG. 5, after customer data is updated (S510), it is determined whether the customer is viable (Return to S506). Alternatively, if it is determined that the customer is viable (Y at S506), then promotion data is correlated with customer data (S512). For example, returning to FIG. 3, one or more processors 302 may execute instructions in customer module 318 to cause one or more enterprise servers 104 to correlate promotion data with customer data.

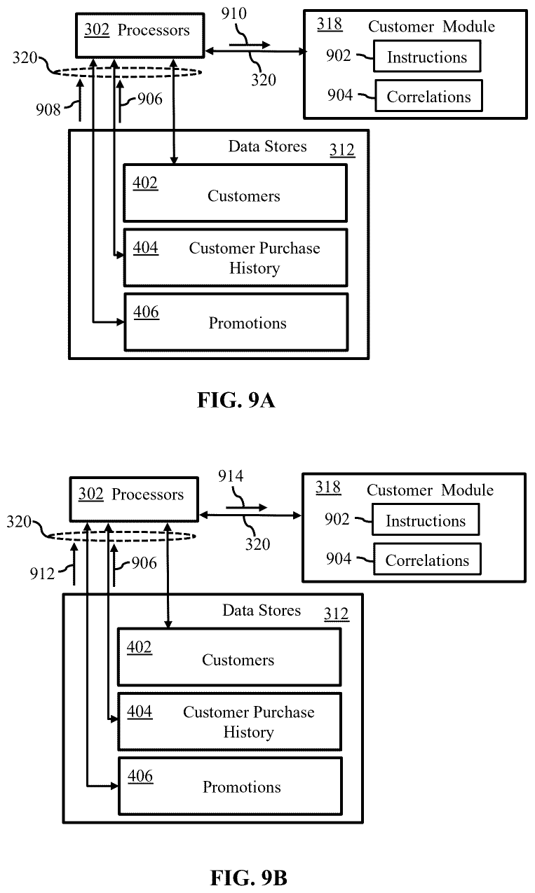

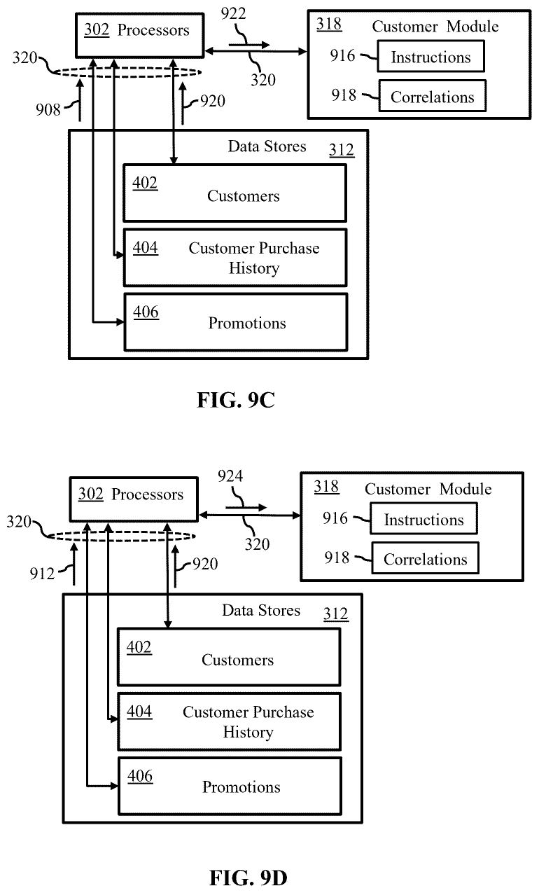

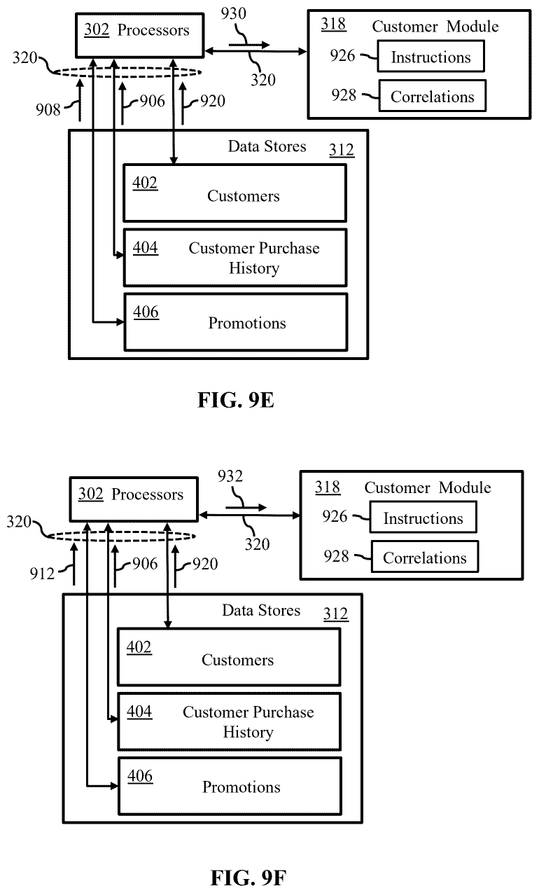

In one or more embodiments, customer data of a viable customer to be correlated with promotion data includes purchase history data of the viable customer. This will be described in greater detail with reference to FIGS. 9A-B.

FIG. 9A illustrates a block diagram of a portion of one or more enterprise servers 104 for determining a correlation between a customer's purchase history and an available promotion at a time t₀ in accordance with aspects of the present disclosure.

In one or more embodiments, as will be described in greater detail below, customer module 318 includes instructions, that when executed by one or more processors 302, cause one or more enterprise servers 104 to: generate a plurality of correlation values, each of which corresponds to a respective correlation between customer data associated with a customer and each of a respective plurality of promotion data relating to a respective plurality of available promotions; identify an optimal available promotion based on a maximum correlation value of the plurality of correlation values; generate an available promotion signal based on the optimal available promotion; and transmit the available promotion signal to a display of UI 712 to cause the display to display information related to the optimal available promotion.

In one or more embodiments, as will be described in greater detail below, customer module 318 includes instructions, that when executed by one or more processors 302, additionally cause one or more enterprise servers 104 to: identify a second available promotion based on a second correlation value of the plurality of correlation values; generate the available promotion signal based on optimal available promotion and the second available promotion; and transmit the available promotion signal to a display of UI 712 to cause the display to display information related to the optimal available promotion and the second available promotion.

In one or more embodiments, as will be described in greater detail below, customer module 318 includes instructions, that when executed by one or more processors 302, additionally cause one or more enterprise servers 104 to generate the plurality of correlation values using a machine learning algorithm. In one or more of these embodiments, as will be described in greater detail below, customer module 318 includes instructions, that when executed by one or more processors 302, additionally cause one or more enterprise servers 104 to generate the plurality of correlation values using a neural network that has been trained via reinforcement learning as the machine learning algorithm. In one or more of these embodiments, as will be described in greater detail below, customer module 318 includes instructions, that when executed by one or more processors 302, additionally cause one or more enterprise servers 104 to generate the plurality of correlation values. In one or more of these embodiments, as will be described in greater detail below, customer module 318 includes instructions, that when executed by one or more processors 302, additionally cause one or more enterprise servers 104 to generate the plurality of correlation values using a neural network that has been trained via reinforcement learning as the machine learning algorithm.

In one or more embodiments, as will be described in greater detail below, customer module 318 includes instructions, that when executed by one or more processors 302, additionally cause one or more enterprise servers 104 to identify the optimal available promotion additionally based on a respective number of other customers associated with each of the respective plurality of promotion data.

In one or more embodiments, as will be described in greater detail below, customer module 318 includes instructions, that when executed by one or more processors 302, additionally cause one or more enterprise servers 104 to identify the optimal available promotion additionally based on a respective time associated with each of the respective plurality of promotion data.

As shown in the figure, customer module 318 includes instructions 902 and a correlations storage area 904 stored therein.

In one or more embodiments, one or more processors 302 may access current customer purchase history data 906 from customer purchase history data storage 404. Non-limiting examples of data within current customer purchase history data 906 includes: purchase type, e.g., the specific good or service purchased; purchase dates; purchase amounts; purchase locations; and combinations thereof.

In one or more embodiments, one or more processors 302 may access additionally access promotion data 908 from promotions data storage 406.

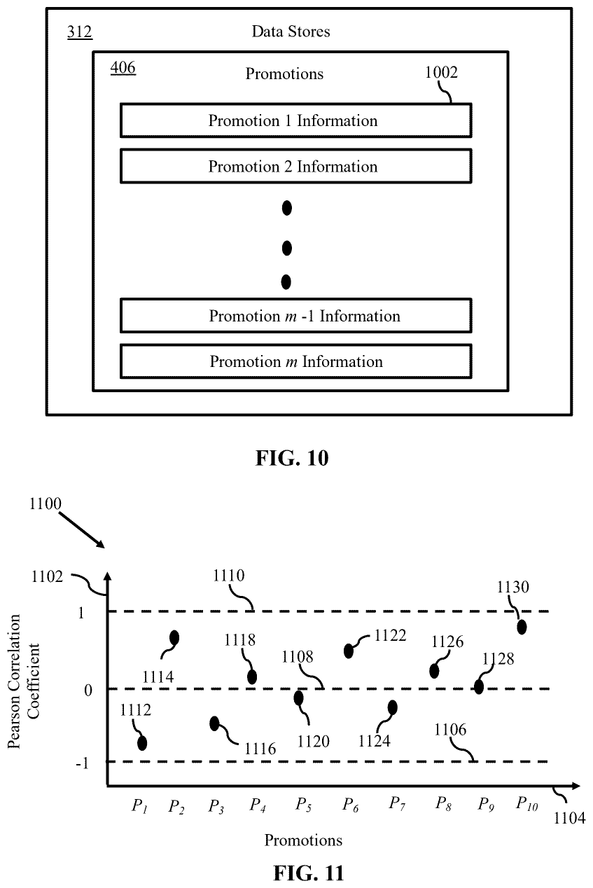

In one or more embodiments, the promotion data may include respective data related to each respective available promotion. This will be described in greater detail with reference to FIG. 10.

FIG. 10 illustrates the promotions data storage displaying available promotions in accordance with aspects of the present disclosure.

As shown in FIG. 10, promotions data storage 406 includes a plurality of available promotion data structures stored therein, a sample of which is indicated as available promotion data structure 1002. Each available promotion data structure includes, respective data related to each respective available promotion, non-limiting examples of which include a promotion title, an introductory rate, an introductory time windows, a standard rate, a transfer rate, a change in credit limit, cash-back reward amount, cash-back reward requirement, travel points reward amount, travel points reward requirement, and combinations thereof.

Returning to FIG. 9A, in one or more embodiments, one or more processors 302 may execute instructions 902 to correlate current customer purchase history data 906 with promotion data 908. For purposes of explanation only, consider a first example situation wherein a customer's purchase history includes 100 different purchases, wherein 80 were to a particular fast food restaurant. Further, in this first example situation, let a promotion that corresponds to the promotion data be a cash-back reward for purchases at that same fast food restaurant. In this first example situation, the customer's purchase history may have a high correlation with the promotion.

Correlation may be calculated in any known manner, a non-limiting example of which includes calculating a Pearson correlation coefficient (r), using the following formula:

$$r = \frac{n \sum xy - ( \sum x ) ( \sum y )}{\sqrt{[ n \sum {x}^{2} - {( \sum x )}^{2} ] [ n \sum {y}^{2} - {( \sum y )}^{2} ]}}$$

where: n is the number of data points, which for this first example is 100 from the 100 purchases; x and y are the variables being correlated, wherein x corresponds to the purchases by the customer and y corresponds to the restaurant, and wherein y may be a constant value; Σxy is the sum of the products of x and y, Σx is the sum of x values; Σy is the sum of y values; Σx² is the sum of squared x values; Σy² is the sum of squared y values.

In one or more embodiments, one or more processors 302 may execute instructions 902 to correlate current customer purchase history data 906 with promotion data 908 using a machine learning algorithm. In one or more of these embodiments, the machine learning algorithm may take the form of a neural network. In one or more of these embodiments, the machine learning algorithm may take the form of a neural network that is trained via reinforcement learning. In one or more of these embodiments, the neural network that is trained via reinforcement learning may evaluate at least one of an address, a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the customer data.

In one or more embodiments, one or more processors 302 may execute instructions 902 to store the currently calculated value of r as a correlation value 910 into correlations storage area 904.

In one or more embodiments, customer data of the viable customer may then be correlated with promotion data from another promotion. This will be described in greater detail with reference to FIG. 9B.

FIG. 9B illustrates a block diagram of a portion of one or more enterprise servers 104 for determining a correlation between a customer's purchase history and another available promotion at a time t₁ in accordance with aspects of the present disclosure.

As shown in the figure, one or more processors 302 may access current customer purchase history data 906 from customer purchase history data storage 404 and additionally access promotion data 912 from promotions data storage 406. In this example, promotion data 912 differs from promotion data 908, as discussed above with reference to FIG. 9A, in that promotion data 912 corresponds to a different promotion in promotions data storage 406, for example as shown in FIG. 10.

In one or more embodiments, one or more processors 302 may execute instructions 902 to correlate current customer purchase history data 906 with promotion data 912, in a manner similar to that discussed above with reference to FIG. 9A.

In one or more embodiments, one or more processors 302 may execute instructions 902 to store the currently calculated value of r as a correlation value 914 into correlations storage area 904.

In one or more embodiments, this correlation process may be repeated for one or more promotions as listed in promotions data storage 406 to generate a plurality of correlation values. This will be described in greater detail with reference to FIG. 11.

FIG. 11 illustrates a plot 1100 of example calculated Pearson correlation coefficients between an example customer data of an example viable customer of enterprise 600 with ten different available promotions.

As shown in the figure, graph 1100 includes a y-axis 1102 that corresponds to a calculated Pearson correlation coefficient of the example first viable customer with respect to an available promotion, whereas x-axis 1104 corresponds to the available promotions.

The calculated Pearson correlation coefficient is measured between the range of [1, −1], wherein a value of +1 indicates a perfect positive correlation, where an increase in one variable corresponds to an increase in the other, a value of −1 indicates a perfect negative correlation, where an increase in one variable corresponds to a decrease in the other, and a value of 0 indicates no linear correlation between the variables.

To aid in visualization of the range of Pearson correlation coefficient, the value of −1 is illustrated via dashed line 1106, the value of 0 is illustrated via dashed line 1108, and the value of 1 is illustrated via dashed line 1110.

An available promotion P₁ has a Pearson correlation coefficient as indicated by dot 1112. An available promotion P₂ has a Pearson correlation coefficient as indicated by dot 1114. An available promotion P₃ has a Pearson correlation coefficient as indicated by dot 1116. An available promotion P₄ has a Pearson correlation coefficient as indicated by dot 1118. An available promotion P₅ has a Pearson correlation coefficient as indicated by dot 1120. An available promotion P₆ has a Pearson correlation coefficient as indicated by dot 1122. An available promotion P₇ has a Pearson correlation coefficient as indicated by dot 1124. An available promotion P₈ has a Pearson correlation coefficient as indicated by dot 1126. An available promotion P₉ has a Pearson correlation coefficient as indicated by dot 1128. An available promotion P₁₀ has a Pearson correlation coefficient as indicated by dot 1130.

In this example, each of available promotions P₁, P₃, P₅, and P₇ has a negative correlation with the customer data. This indicates that none of promotions P₁, P₃, P₅, and P₇ would likely benefit the example viable customer. Further, promotion P₉ has a zero correlation with the customer data. This indicates that promotion P₉ would also not likely benefit the example viable customer. Furthermore, each of available promotions P₂, P₄, P₆, P₈, and P₁₀ has a positive correlation with the customer data. This indicates that any of promotions P₂, P₄, P₆, P₈, and P₁₀ would likely benefit the example viable customer. More importantly, promotion P₁₀ has the greatest correlation, which indicates that promotion P₁₀ is the optimal available promotion for this example viable customer.

In one or more embodiments, one or more processors 302 may execute instructions 902 to store the corresponding calculated values of r into correlations storage area 904.

In one or more embodiments, customer data of a viable customer to be correlated with promotion data includes customer address data of the viable customer. This will be described in greater detail with reference to FIGS. 9C-D.

FIG. 9C illustrates a block diagram of a portion of one or more enterprise servers 104 for determining a correlation between a customer's address and an available promotion at a time t₂ in accordance with aspects of the present disclosure.

As shown in the figure, customer module 318 includes instructions 916 and a correlations storage area 918 stored therein.

In one or more embodiments, one or more processors 302 may access current customer address data 920 from customers data storage 404.

In one or more embodiments, one or more processors 302 may access additionally access promotion data 908 from promotions data storage 406.

In one or more embodiments, one or more processors 302 may execute instructions 916 to correlate current customer address data 920 with promotion data 908. For purposes of explanation only, consider a second example situation wherein a promotion that corresponds to the promotion data be a cash-back reward for purchases at a fast food restaurant, and let the customer's address be located very near to the address of the fast food restaurant. In this second example situation, the customer's address may have a high correlation with the promotion.

In a manner similar to that discussed above with reference to FIGS. 9A and 10, current customer address data 920 may be correlated with promotion data 908.

In one or more embodiments, one or more processors 302 may execute instructions 916 to store the currently calculated value of r as a correlation value 922 into correlations storage area 918.

In one or more embodiments, customer data of the viable customer may then be correlated with promotion data from another promotion. This will be described in greater detail with reference to FIG. 9D.

FIG. 9D illustrates a block diagram of a portion of one or more enterprise servers 104 for determining a correlation between a customer's address and another available promotion at a time t₃ in accordance with aspects of the present disclosure.

As shown in the figure, one or more processors 302 may access current customer address data 920 from customers data storage 402 and additionally access promotion data 912 from promotions data storage 406.

In a manner similar to that discussed above with reference to FIGS. 9A and 10, current customer address data 920 may be correlated with promotion data 912.

In one or more embodiments, one or more processors 302 may execute instructions 916 to store the currently calculated value of r as a correlation value 924 into correlations storage area 918.

In one or more embodiments, this correlation process may be repeated for one or more promotions as listed in promotions data storage 406 to generate a plurality of correlation values and store the corresponding calculated values of r into correlations storage area 918.

In one or more embodiments, customer data of a viable customer to be correlated with promotion data includes customer purchase history data and customer address data of the viable customer. This will be described in greater detail with reference to FIGS. 9E-F.

FIG. 9E illustrates a block diagram of a portion of one or more enterprise servers 104 for determining a correlation between a customer's purchase history and a customer's address and an available promotion at a time t₄ in accordance with aspects of the present disclosure.

As shown in the figure, customer module 318 includes instructions 926 and a correlations storage area 928 stored therein.

In one or more embodiments, one or more processors 302 may access current customer purchase history data 906 from customer purchase history storage 404, current customer address data 920 from customers data storage 404, and promotion data 906 from promotions data storage 406.

In one or more embodiments, one or more processors 302 may execute instructions 926 to correlate current customer purchase history data 906 and current customer address data 920 with promotion data 908. For purposes of explanation only, consider a third example situation wherein a promotion that corresponds to the promotion data be a cash-back reward for purchases at a fast food restaurant, let the customer's address be located very near to the address of the fast food restaurant, and let 80 of 100 of the customer's purchases be at that fast food restaurant. In this third example situation, the customer's address may have a high correlation with the promotion.

In a manner similar to that discussed above with reference to FIGS. 9A, 9C and 10, current customer purchase history data 906 and current customer address data 920 may be correlated with promotion data 908.

In one or more embodiments, one or more processors 302 may execute instructions 926 to store the currently calculated value of r as a correlation value 930 into correlations storage area 928.

In one or more embodiments, customer data of the viable customer may then be correlated with promotion data from another promotion. This will be described in greater detail with reference to FIG. 9F.

FIG. 9F illustrates a block diagram of a portion of one or more enterprise servers 104 for determining a correlation between a customer's purchase history and the customer's address with another available promotion at a time t₅ in accordance with aspects of the present disclosure.

As shown in the figure, one or more processors 302 may access current customer purchase history data 906 from customer purchase history storage 404, current customer address data 920 from customers data storage 402 and additionally access promotion data 912 from promotions data storage 406.

In a manner similar to that discussed above with reference to FIGS. 9A, 9C and 10, current customer purchase history data 906 and current customer address data 920 may be correlated with promotion data 912.

In one or more embodiments, one or more processors 302 may execute instructions 926 to store the currently calculated value of r as a correlation value 932 into correlations storage area 928.

In one or more embodiments, this correlation process may be repeated for one or more promotions as listed in promotions data storage 406 to generate a plurality of correlation values.

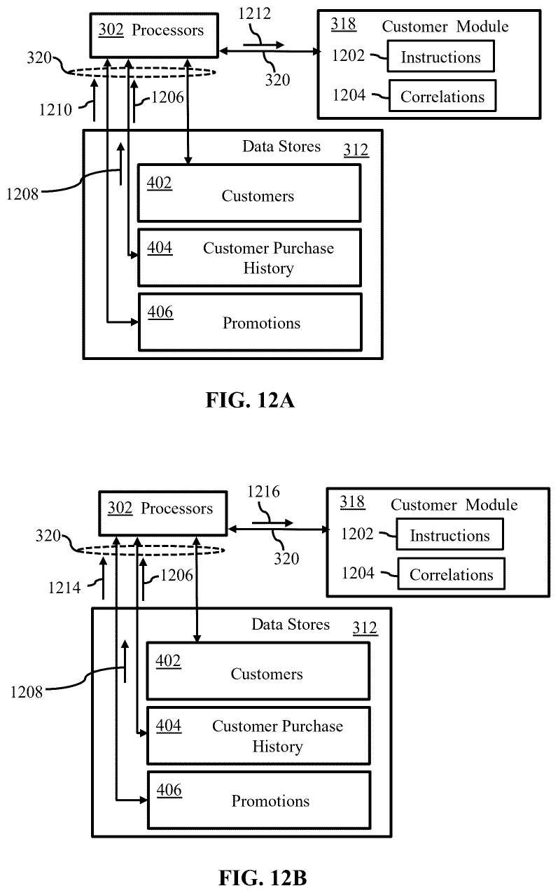

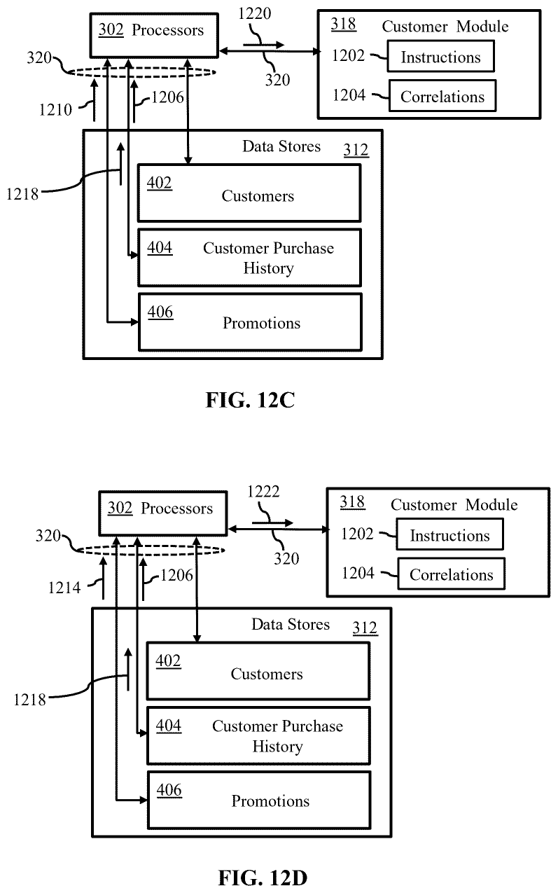

FIG. 12A illustrates a block diagram of a portion of one or more enterprise servers of FIG. 3 for determining a correlation between a customer's purchase history and another customer's purchase history that is currently using an available promotion at a time t₆ in accordance with aspects of the present disclosure.

As shown in the figure, one or more processors 302 may access current customer purchase history data 1206 from customer purchase history data storage 404, access another customer's purchase history data 1208 from customer purchase history data storage 404 and additionally access promotion data 1210 from promotions data storage 406.

In one or more embodiments, one or more processors 302 may execute instructions 1202 to correlate current customer purchase history data 1206 with the another customer's purchase history data 1208 and with promotion data 1210.

In one or more embodiments, one or more processors 302 may execute instructions 1202 to store the currently calculated value of r as a correlation value 1212 into correlations storage area 1204.

In one or more embodiments, this correlation process may be repeated for one or more promotions as listed in promotions data storage 406 to generate a plurality of correlation values. This will be described in greater detail with reference to FIG. 12B.

FIG. 12B illustrates a block diagram of a portion of one or more enterprise servers of FIG. 3 for determining a correlation between a customer's purchase history and another customer's purchase history that is currently using another available promotion at a time t₇ in accordance with aspects of the present disclosure.

As shown in the figure, one or more processors 302 may access current customer purchase history data 1206 from customer purchase history data storage 404, access another customer's purchase history data 1208 from customer purchase history data storage 404 and additionally access promotion data 1214 from promotions data storage 406. It should be noted that promotion data 1214 differs from promotion data 1210 discussed above with referent to FIG. 12A in that promotion data 1214 corresponds to a different available promotion as compared to that of promotion data 1210.

In one or more embodiments, one or more processors 302 may execute instructions 1202 to correlate current customer purchase history data 1206 with the another customer's purchase history data 1208 and with promotion data 1214.

In one or more embodiments, one or more processors 302 may execute instructions 1202 to store the currently calculated value of r as a correlation value 1216 into correlations storage area 1204.

FIG. 12C illustrates a block diagram of a portion of one or more enterprise servers of FIG. 3 for determining a correlation between a customer's purchase history and yet another customer's purchase history that is currently using an available promotion at a time t₈ in accordance with aspects of the present disclosure.

As shown in the figure, one or more processors 302 may access current customer purchase history data 1206 from customer purchase history data storage 404, access another customer's purchase history data 1218 from customer purchase history data storage 404 and additionally access promotion data 1210 from promotions data storage 406. It should be noted that the another customer's purchase history data 1218 differs from the another customer's purchase history data 1208 discussed above with reference to FIGS. 12A-B, in that the another customer's purchase history data 1218 corresponds to a customer that is different than the customer corresponding to the another customer's purchase history data 1208.

In one or more embodiments, one or more processors 302 may execute instructions 1202 to correlate current customer purchase history data 1206 with the another customer's purchase history data 1218 and with promotion data 1210.

In one or more embodiments, one or more processors 302 may execute instructions 1202 to store the currently calculated value of r as a correlation value 1220 into correlations storage area 1204.

In one or more embodiments, this correlation process may be repeated for one or more promotions as listed in promotions data storage 406 to generate a plurality of correlation values.

FIG. 12D illustrates a block diagram of a portion of one or more enterprise servers of FIG. 3 for determining a correlation between a customer's purchase history and another customer's purchase history that is currently using another available promotion at a time t₉ in accordance with aspects of the present disclosure.

As shown in the figure, one or more processors 302 may access current customer purchase history data 1206 from customer purchase history data storage 404, access another customer's purchase history data 1218 from customer purchase history data storage 404 and additionally access promotion data 1214 from promotions data In one or more embodiments, one or more processors 302 may execute instructions 1202 to correlate current customer purchase history data 1206 with the another customer's purchase history data 1218 and with promotion data 1214.

In one or more embodiments, one or more processors 302 may execute instructions 1202 to store the currently calculated value of r as a correlation value 1222 into correlations storage area 1204.

In one or more embodiments, this correlation process may be repeated for one or more promotions as listed in promotions data storage 406 to generate a plurality of correlation values.

With respect to FIGS. 12A-12D discussed above, in one or more embodiments, a current customer's purchase history may be correlated with a plurality of different customer's respective purchase history and with a plurality of different available promotions to generate a plurality of different correlations. In this manner, the current customer may be compared with other customers to identify those other customers that have a purchase history that is similar to that of the current customer. Further, for those customers that have a purchase history that is similar to the current customer, their correlation with the different available promotions may be used to find an optimal available promotion for the current customer.

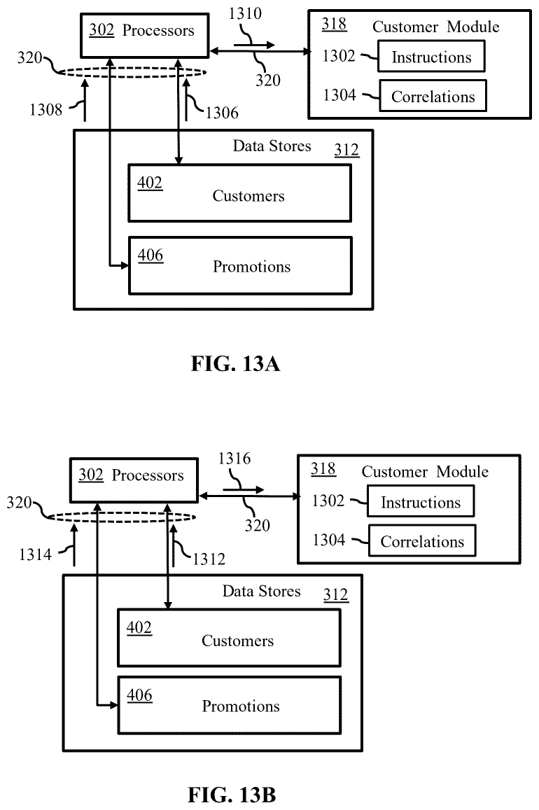

In one or more embodiments, a different customer's respective purchase histories may be correlated with a time of use of respective available promotions to generate a plurality of different correlations. This will be described in greater detail with reference to FIGS. 13A-B.

FIG. 13A illustrates a block diagram of a portion of one or more enterprise servers of FIG. 3 for determining a promotion time value between a customer's customer data and an available promotion at a time t₈ in accordance with aspects of the present disclosure.

In one or more embodiments, data for each customer within customer data storage 402 may include a first data field indicating which promotion that customer is currently using, and a second data field indicating the length of time for which that customer has been using the promotion. As shown in the figure, one or more processors 302 may access a first customer's promotion data 1306 from customer data storage 402, wherein the first customer's promotion data 1306 includes a pointer pointing to the location of the promotion used by the first customer within promotions storage 406 and the length of time for which the promotion has been used by the first customer. Further, one or more processors 302 may access promotion data 1308 corresponding to the promotion associated with the pointer of the first customer's promotion data 1306.

In one or more embodiments, one or more processors 302 may execute instructions 1302 to store a promotion time value 1310, based on the promotion data 1308 and the length of time for which the promotion has been used by the first customer from the first customer's promotion data 1306, into correlations storage area 1304.

In one or more embodiments, this process for storing promotion time values may be repeated for one or more promotions as listed in promotions data storage 406 to generate a plurality of promotion time values. This will be described in greater detail with reference to FIG. 13B.

FIG. 13B illustrates a block diagram of a portion of one or more enterprise servers of FIG. 3 for determining a promotion time value between another customer's purchase history and another available promotion at a time t₉ in accordance with aspects of the present disclosure.

In one or more embodiments, one or more processors 302 may access a second customer's promotion data 1312 from customer data storage 402, wherein the second customer's promotion data 1312 includes a pointer pointing to the location of the promotion used by the second customer within promotions storage 406 and the length of time for which the promotion has been used by the second customer. Further, one or more processors 302 may access promotion data 1314 corresponding to the promotion associated with the pointer of the second customer's promotion data 1312.

In one or more embodiments, one or more processors 302 may execute instructions 1302 to store a promotion time value 1316, based on the promotion data 1314 and the length of time for which the promotion has been used by the second customer from the second customer's promotion data 1312, into correlations storage area 1304.

After storing a predetermined number of promotion time values, an optimal correlation value may be determined.

In one or more embodiments, one or more processors 302 may execute instructions 1302 to determine an optimal correlation value based on the largest average time value of all the promotions. For example, for purposes of discussion only, consider a situation wherein one or more processors 302 had stored a plurality of promotion time values into correlations storage area 1304. In one or more embodiments, one or more processors 302 may execute instructions 1032 to determine an average time, for each promotion, that a customer for that respective promotion has been using that respective promotion. Again, for purposes of discussion only, let a promotion P_{longest}, having an average time of use by a customer of 426 days, be the promotion having the largest average time of all the promotions. In this case, promotion P_{longest}, would have an optimal correlation value.

In one or more embodiments, one or more processors 302 may execute instructions 1302 to determine an optimal correlation value based on the largest number of customers using a single promotion. For example, for purposes of discussion only, consider a situation wherein one or more processors 302 had stored a plurality of promotion time values into correlations storage area 1304. In one or more embodiments, one or more processors 302 may execute instructions 1032 to determine which promotion, of all the promotions associated with the plurality of promotion time values, is being used by the largest number of customers. Again, for purposes of discussion only, let a promotion P_{Popular}, be the promotion that is being used by the largest number of customers. In this case, promotion P_{Popular}, would have an optimal correlation value.

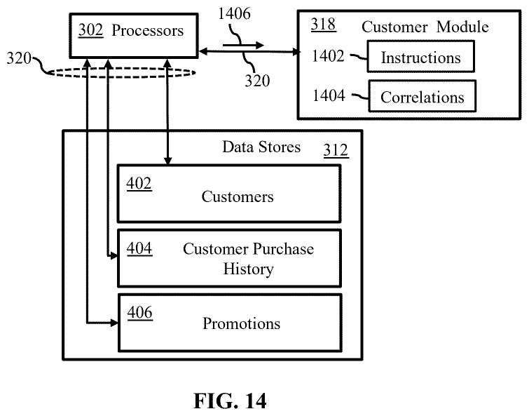

FIG. 14 illustrates a block diagram of a portion of one or more enterprise servers of FIG. 3 for determining a correlation using a combination of the embodiments discussed in FIGS. 12A-13B in accordance with aspects of the present disclosure.

In one or more embodiments, one or more processors 302 may may access current customer purchase history data from customer purchase history data storage 404, access another customer's purchase history data from customer purchase history data storage 404 and additionally access promotion data from promotions data storage 406, as discussed above with reference to FIGS. 12A-B, and may access a customer's promotion data from customer data storage 402, as discussed above with reference to FIGS. 13A-B, to generate a plurality of correlation values using a combination of correlation value generating methods discussed above with reference to FIGS. 12A-13B.

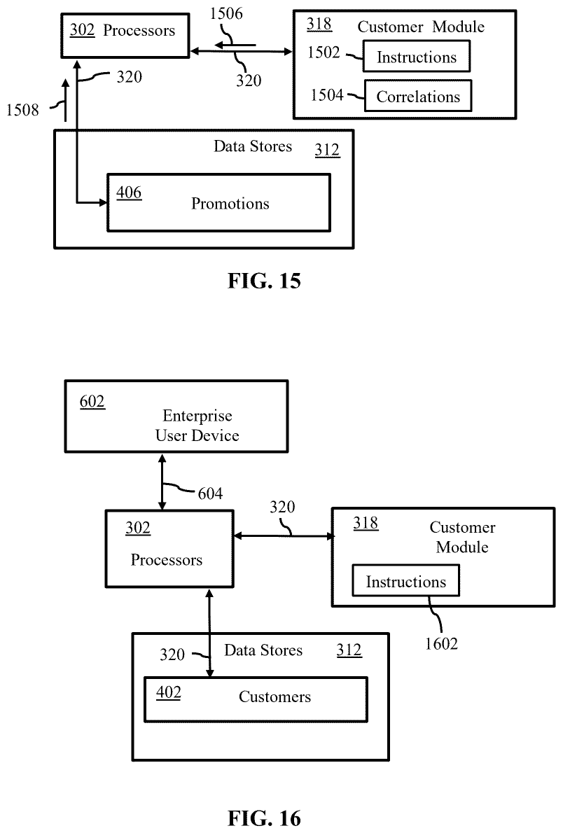

Returning to FIG. 5, after promotion data is correlated with customer data (S512), an optimal promotion is identified (S514). For example, returning to FIG. 3, one or more processors 302 may execute instructions in customer module 318 to cause one or more enterprise servers 104 to identify an optimal promotion. This will be described in greater detail with reference to FIG. 15.

FIG. 15 illustrates a block diagram of a portion of one or more enterprise servers of FIG. 3 for identifying an optimal promotion in accordance with aspects of the present disclosure.

As shown in the figure, customer module 318 includes instructions 1502 and a correlations storage area 1504 stored therein.

In one or more embodiments, one or more processors 302 may obtain the highest correlation value r within correlations storage area 1504 as optimum correlation 1206. Further, one or more processors 302 may obtain promotion information 1508 corresponding to optimal available promotion from promotions data storage area 406, and which corresponds to optimum correlation 1506.

Returning to FIG. 5, after the optimal promotion is identified (S514), it is determined whether the customer is currently using a promotion (S516). For example, returning to FIG. 3, one or more processors 302 may execute instructions in customer module 318 to cause one or more enterprise servers 104 to determine whether the customer is using a promotion. This will be described in greater detail with reference to FIG. 16.

FIG. 16 illustrates a block diagram of a portion of one or more enterprise servers of FIG. 3 for identifying whether a customer is currently using an available promotion in accordance with aspects of the present disclosure.

As shown in the figure, customer module 318 includes instructions 1602.

In one or more embodiments, customers data storage 402 may include an active promotion data field and a promotion title data field for each customer. In one or more embodiments, the active promotion data field may be a flag that indicates whether or not a respective customer is actively using a promotion. In one or more embodiments, the promotion title data field may include a promotion pointer that points to one of the available promotions within promotions data storage 406, for which a respective customer is actively using, if the active promotion data field flag is checked.

In one or more embodiments, one or more processors 302 may execute instructions 1602 to cause one or more processors 302 to determine from an active promotion data field for a customer's data withing customers data storage 402. One or more processors may further execute instructions 1602 to cause one or more processors to determine that the customer is currently using a promotion when the flag is set and determine that the customer is not currently using a promotion when the flag is clear.

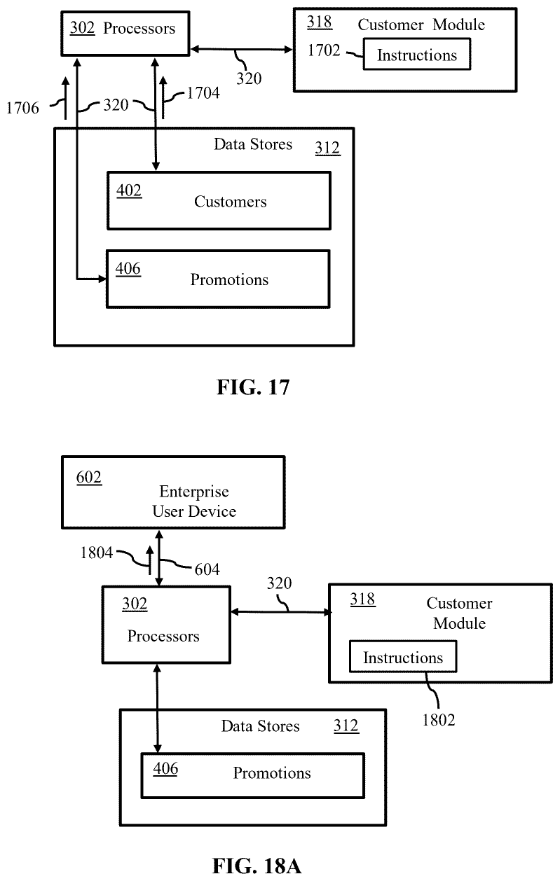

Returning to FIG. 5, if it is determined that the customer is currently using a promotion (Y at S516), it is then determined whether the customer's currently used promotion is the optimal available promotion (S518). For example, returning to FIG. 3, one or more processors 302 may execute instructions in customer module 318 to cause one or more enterprise servers 104 to determine whether the promotion being currently used by a customer is the optimal available promotion. This will be described in greater detail with reference to FIG. 17.

FIG. 17 illustrates a block diagram of a portion of one or more enterprise servers of FIG. 3 for identifying whether a customer's currently used promotion is the optimal available promotion.

As shown in the figure, customer module 318 includes instructions 1702.

In one or more embodiments, one or more processors 302 may execute instructions 1702 to cause one or more processors 302 to obtain a promotion pointer 1704 from customers data storage 402 that points to one of the available promotions within promotions data storage 406, for which the customer is actively using. In one or more embodiments, one or more processors 302 may then execute instructions 1702 to cause one or more processors 302 to obtain promotion information 1706, from promotions storage 406, that corresponds to promotion pointer 1704.

In one or more embodiments, one or more processors 302 may then execute instructions 1702 to cause one or more processors 302 to compare promotion information 1706 with promotion information 1508 (see S514 discussed above). If promotion information 1706 and promotion information 1508 correspond to the same promotion in promotions storage 406, then the currently used promotion by the customer is the optimal available promotion. Alternatively, if promotion information 1706 and promotion information 1508 correspond to different promotions in promotions storage 406, then the currently used promotion by the customer is not the optimal available promotion.

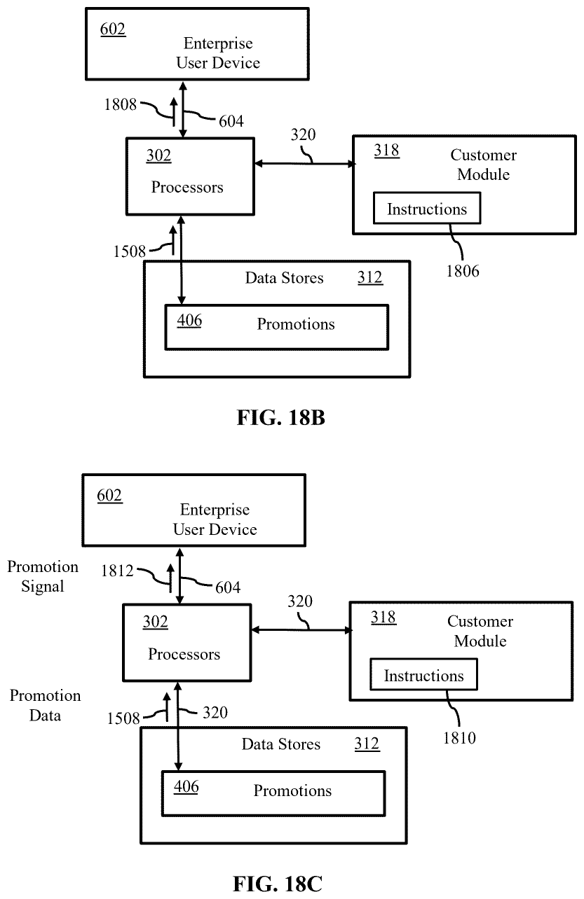

Returning to FIG. 5, if it is determined that the customer's currently used promotion is the optimal available promotion (Y at S518), then an acknowledge promotion message is generated (S520). For example, returning to FIG. 3, one or more processors 302 may execute instructions in customer module 318 to cause one or more enterprise servers 104 to generate an acknowledge promotion signal to cause enterprise user device 602 to generate an acknowledge promotion message. This will be described in greater detail with reference to FIG. 18A.

FIG. 18A illustrates a block diagram of a portion of one or more enterprise servers of FIG. 3 and enterprise user device 602 for displaying information related to acknowledging a currently used promotion in accordance with aspects of the present disclosure.

As shown in FIG. 18A, customer module 318 includes instructions 1802 stored therein.

One or more processors 302 may execute instructions 1802 to cause one or more one or more processors 302 to generate an acknowledge promotion signal 1804 based on promotion information 1706, which corresponds to the promotion that the customer is currently using. In one or more embodiments, the promotion that the customer is currently using is determined from customers data storage 402, as discussed above (S516) which may include an active promotion data field and a promotion title data field for the customer.

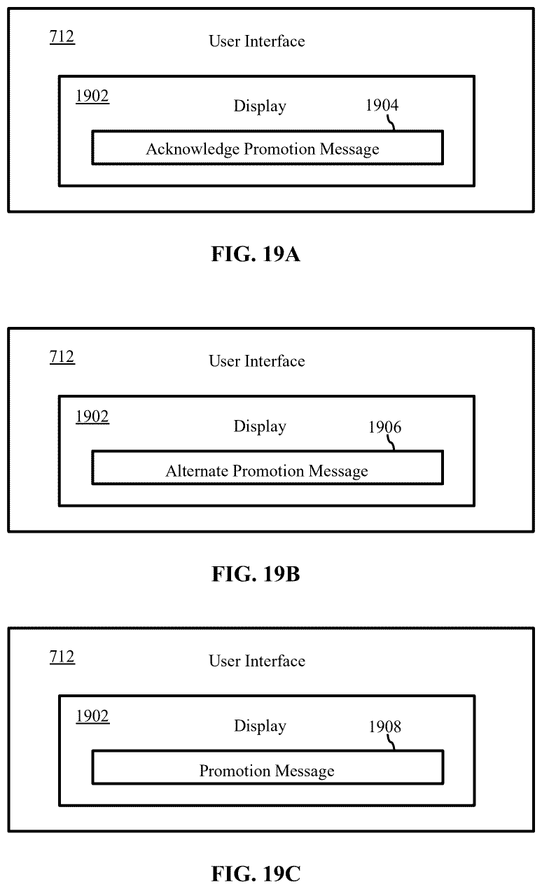

Upon receiving acknowledge promotion signal 1804, enterprise user device 602 is configured to display information related to acknowledging a currently used promotion. For example, returning to FIG. 7, upon receiving acknowledge promotion signal 1804, system controller 702 may executed instructions within customer program 706 to cause UI 712 to display to display information related to acknowledging the customer's currently used promotion. This will be described in greater detail with reference to FIG. 19A.

FIG. 19A illustrates UI 712 of enterprise user device 602 displaying an acknowledge promotion message in accordance with aspects of the present disclosure. As shown in the figure, UI 712 includes a display 1902 displaying a predetermined acknowledge promotion message 1904.

For purposes of explanation, consider the situation wherein a customer calls enterprise 600 to speak with a representative. Further, let the representative be using enterprise user device 602. Upon speaking with the customer, and with reference to FIGS. 4, 6 and 7, the representative may access information of the customer from any one of customer data storage 402, customer purchase history storage 404, or promotions data storage 406 via UI 712 of enterprise user device 602.

Further, in one or more embodiments, customer module 318 may have instructions stored therein, that when executed by one or more processors 302, cause one or more enterprise servers 104 to instruct user interface 712 of enterprise user device 602 to display a message for the representative, “I see that you have been using our promotion ______. I hope you are enjoying it,” wherein the blank is filled in with promotion title of the promotion that the customer is currently using.

In the one or more embodiments wherein the machine learning algorithm takes the form of a neural network that is trained via reinforcement learning, the reinforcement learning algorithm enables one or more processors 302 of one or more enterprise servers 104 to execute instructions 902 in customer module 318 to correlate current customer purchase history data with promotion data to generate an acknowledge promotion message in real time.

Returning to FIG. 5, after an acknowledge promotion message is generated (S520), method 500 stops (S522). If it is determined that the customer's currently used promotion is not the optimal available promotion (N at S518), then an alternate promotion message is generated (S524). For example, returning to FIG. 3, one or more processors 302 may execute instructions in customer module 318 to cause one or more enterprise servers 104 to generate an alternate promotion signal to cause enterprise user device 602 to generate an alternate promotion message. This will be described in greater detail with reference to FIG. 18B.

FIG. 18B illustrates a block diagram of a portion of one or more enterprise servers of FIG. 3 and enterprise user device 602 for displaying information related to informing of an alternate promotion in accordance with aspects of the present disclosure.

As shown in FIG. 18B, customer module 318 includes instructions 1806 stored therein.

One or more processors 302 may execute instructions 1806 to cause one or more one or more processors 302 to generate an alternate promotion signal 1808 based on promotion information 1508, which corresponds to the optimal available promotion and that which the customer is currently not using.

Upon receiving alternate promotion signal 1808, enterprise user device 602 is configured to display information related to the optimal available promotion. For example, returning to FIG. 7, upon receiving alternate promotion signal 1808, system controller 702 may execute instructions within customer program 706 to cause UI 712 to display to display information related an optimal available promotion. This will be described in greater detail with reference to FIG. 19B.

FIG. 19B illustrates UI 712 of enterprise user device 602 displaying an alternate promotion message in accordance with aspects of the present disclosure. As shown in the figure, UI 712 includes display 1902 displaying a predetermined alternate promotion message 1906.

For purposes of explanation, consider the situation wherein a customer calls enterprise 600 to speak with a representative. Further, let the representative be using enterprise user device 602. Upon speaking with the customer, and with reference to FIGS. 4, 6 and 7, the representative may access information of the customer from any one of customer data storage 402, customer purchase history storage 404, or promotions data storage 406 via UI 712 of enterprise user device 602.

Further, in one or more embodiments, customer module 318 may have instructions stored therein, that when executed by one or more processors 302, cause one or more enterprise servers 104 to instruct user interface 712 of enterprise user device 602 to display a message for the representative, “I see that you have been using our promotion ______. However, you may want to consider using our alternate promotion ______, because the benefits that you will receive from this promotion seem to benefit you most based on your past purchase history,” wherein the first blank is filled in with promotion title of the promotion that the customer is currently using, and the second blank is filled in with the promotion title of the optimal available promotion.

In the one or more embodiments wherein the machine learning algorithm takes the form of a neural network that is trained via reinforcement learning, the reinforcement learning algorithm enables one or more processors 302 of one or more enterprise servers 104 to execute instructions 902 in customer module 318 to correlate current customer purchase history data with promotion data to generate an alternate promotion message in real time.

Returning to FIG. 5, after an alternate promotion message is generated (S524), method 500 stops (S522).

In the above-discussed non-limiting example embodiment, an alternate promotion message is generated to assist an enterprise employee in describing an optimal promotion for a current customer. However, in one or more embodiments, an alternate promotion message may be generated to assist an enterprise employee in describing at least one more promotion for a current customer.

For example, when identifying an optimal promotion (S514), in one or more embodiments, as shown in FIG. 15 one or more processors 302 may obtain some predetermined number m of the highest correlation values within correlations storage area 1504. Further, one or more processors 302 may obtain promotion information corresponding to the predetermined number m of the highest correlation values from promotions data storage area 406. For example, returning to FIG. 11, one or more processors 302 may obtain promotion information corresponding to the three highest correlation values, which in this case is promotions P₂, P₆, and P₁₀.

As such, returning to FIG. 5, when generating an alternate promotion message (S524), in this example, customer module 318 may have instructions stored therein, that when executed by one or more processors 302, cause one or more enterprise servers 104 to instruct user interface 712 of enterprise user device 602 to display a message for the representative, “I see that you have been using our promotion ______. However, you may want to consider using one of three of our alternate promotions ______, because the benefits that you will receive from these promotion seem to benefit you most based on your past purchase history,” wherein the first blank is filled in with promotion title of the promotion that the customer is currently using, and the second blank is filled in with the three promotion titles of the three highest correlated available promotions.

If it is determined that the customer is not currently using a promotion (N at S516), then a promotion message is generated (S526). For example, returning to FIG. 3, one or more processors 302 may execute instructions in customer module 318 to cause one or more enterprise servers 104 to generate a promotion signal to cause enterprise user device 602 to generate a promotion message. This will be described in greater detail with reference to FIG. 18C.

FIG. 18C illustrates a block diagram of a portion of one or more enterprise servers of FIG. 3 and enterprise user device 602 for displaying information related to informing of a promotion in accordance with aspects of the present disclosure.

As shown in FIG. 18C, customer module 318 includes instructions 1810 stored therein.

One or more processors 302 may execute instructions 1806 to cause one or more one or more processors 302 to generate a promotion signal 1812 based on promotion information 1508, which corresponds to the optimal available promotion.

Upon receiving promotion signal 1812, enterprise user device 602 is configured to display information related to the optimal available promotion. For example, returning to FIG. 7, upon receiving alternate promotion signal 1808, system controller 702 may execute instructions within customer program 706 to cause UI 712 to display to display information related an optimal available promotion. This will be described in greater detail with reference to FIG. 19C.

FIG. 19C illustrates UI 712 of enterprise user device 602 displaying a promotion message in accordance with aspects of the present disclosure. As shown in the figure, UI 712 includes display 1902 displaying a predetermined promotion message 1908.

For purposes of explanation, consider the situation wherein a customer calls enterprise 600 to speak with a representative. Further, let the representative be using enterprise user device 602. Upon speaking with the customer, and with reference to FIGS. 4, 6 and 7, the representative may access information of the customer from any one of customer data storage 402, customer purchase history storage 404, or promotions data storage 406 via UI 712 of enterprise user device 602.

Further, in one or more embodiments, customer module 318 may have instructions stored therein, that when executed by one or more processors 302, cause one or more enterprise servers 104 to instruct user interface 712 of enterprise user device 602 to display a message for the representative, “I see that you have not been using any of our promotions. You may want to consider using our promotion ______. because the benefits that you will receive from this promotion seem to benefit you most based on your past purchase history,” wherein the blank is filled in with the promotion title of the optimal available promotion.

In the one or more embodiments wherein the machine learning algorithm takes the form of a neural network that is trained via reinforcement learning, the reinforcement learning algorithm enables one or more processors 302 of one or more enterprise servers 104 to execute instructions 902 in customer module 318 to correlate current customer purchase history data with promotion data to generate a promotion message in real time.

Returning to FIG. 5, after a promotion message is generated (S526), method 500 stops (S522).

In the above-discussed non-limiting example embodiment, a promotion message is generated to assist an enterprise stakeholder in describing an optimal promotion for a current customer. However, in one or more embodiments, a promotion message may be generated to assist an enterprise stakeholder in describing at least one more promotion for a current customer.

For example, as discussed above, when identifying an optimal promotion (S514), in one or more embodiments, as shown in FIG. 15 one or more processors 302 may obtain some predetermined number m of the highest correlation values within correlations storage area 1504. Using the example discussed above with reference to the three highest correlated promotions of FIG. 11, which are promotions P₂, P₆, and P₁₀, when generating a promotion message (S526), customer module 318 may have instructions stored therein, that when executed by one or more processors 302, cause one or more enterprise servers 104 to instruct user interface 712 of enterprise user device 602 to display a message for the representative, “I see that you have not been using any of our promotions. You may want to consider using one of three of our promotions ______, because the benefits that you will receive from these promotions seem to benefit you most based on your past purchase history,” wherein the blank is filled in with the three promotion titles of the three highest correlated available promotions.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to enable others skilled in the art to best utilize the invention in various embodiments and with various modifications as are suited to the particular use contemplated. It is intended that the scope of the invention be defined by the claims appended hereto.

1. A server computing system, comprising:
a processor; and
a non-transitory memory, coupled to the one or more processors, having stored therein, customer data associated with a customer, a plurality of promotion data relating to a respective plurality of available promotions, and a set of instructions of computer-executable program code, which when executed by the processor, cause the processor to perform operations including:
generating a plurality of correlation values, each of which corresponds to a respective correlation between the customer data and each of the respective plurality of promotion data using a neural network that has been trained via reinforcement learning,
storing each of the plurality of correlation values in a correlation storage area of the non-transitory memory,
identifying an optimal available promotion as one of the plurality of available promotions related to a promotion data having a greatest stored correlation value of the plurality of stored correlation values,
generating an available promotion signal based on the optimal available promotion, and
transmitting the available promotion signal to a client device to cause display of information related to the optimal available promotion on a user interface of the client device.

2. The server computing system of claim 1, wherein the set of instructions, which when executed by the processor, cause the processor to perform operations including:
identifying a second available promotion based on a second correlation value of the plurality of correlation values;
generating the available promotion signal based on optimal available promotion and the second available promotion; and
transmitting the available promotion signal to a client device to cause display of information related to the optimal available promotion and the second available promotion on the user interface of the client device.

3-4. (canceled)

5. The server computing system of claim 4, wherein the set of instructions, which when executed by the processor, cause the processor to perform operations including generating the plurality of correlation values using the neural network that has been trained via reinforcement learning to evaluate at least one of an address, a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the customer data.

6. The server computing system of claim 1, wherein the set of instructions, which when executed by the processor, cause the processor to perform operations including identifying the optimal available promotion additionally based on a respective number of other customers associated with each of the respective plurality of promotion data.

7. The server computing system of claim 1, wherein the set of instructions, which when executed by the processor, cause the processor to perform operations including identifying the optimal available promotion additionally based on a respective time associated with each of the respective plurality of promotion data.

8. A computer-implemented method of operating a system for implementation by a processor of a server computing system, said computer-implemented method comprising:
generating customer data associated with a customer and a plurality of promotion data relating to a respective plurality of available promotions, a plurality of correlation values, each of which corresponds to a respective correlation between the customer data and each of the respective plurality of promotion data using a neural network that has been trained via reinforcement learning;
storing each of the plurality of correlation values in a correlation storage area of a non-transitory memory:
identifying an optimal available promotion as one of the plurality of available promotions related to a promotion data having a greatest stored correlation value of the plurality of stored correlation values;
generating an available promotion signal based on the optimal available promotion; and
transmitting the available promotion signal to a client device to cause display of information related to the optimal available promotion on a user interface of the client device.

9. The computer-implemented method of claim 8, further comprising:
identifying a second available promotion based on a second correlation value of the plurality of correlation values;
generating the available promotion signal based on optimal available promotion and the second available promotion; and
transmitting the available promotion signal to a client device to cause display of information related to the optimal available promotion and the second available promotion on the user interface of the client device.

10-11. (canceled)

12. The computer-implemented method of claim 11, wherein said generating the plurality of correlation values using a neural network that has been trained via reinforcement learning as the machine learning algorithm comprises generating the plurality of correlation values using the neural network that has been trained via reinforcement learning to evaluate at least one of an address, a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the customer data.

13. The computer-implemented method of claim 8, wherein said identifying the optimal available promotion comprises identifying the optimal available promotion additionally based on a respective number of other customers associated with each of the respective plurality of promotion data.

14. The computer-implemented method of claim 8, wherein said identifying the optimal available promotion comprises identifying the optimal available promotion additionally based on a respective time associated with each of the respective plurality of promotion data.

15. A computer program product comprising at least one non-transitory computer readable medium having a set of instructions of computer-executable program code, which when executed by a processor of an enterprise computer server system, cause the processor to perform a computer-implemented method comprising:
generating customer data associated with a customer and a plurality of promotion data relating to a respective plurality of available promotions, a plurality of correlation values, each of which corresponds to a respective correlation between the customer data and each of the respective plurality of promotion data using a neural network that has been trained via reinforcement learning;
storing each of the plurality of correlation values in a correlation storage area of a non-transitory memory:
identifying an optimal available promotion as one of the plurality of available promotions related to a promotion data having a greatest stored correlation value of the plurality of stored correlation values;
generating an available promotion signal based on the optimal available promotion; and
transmitting the available promotion signal to a client device to cause display of information related to the optimal available promotion on a user interface of the client device.

16. The computer program product of claim 15, wherein the set of instructions, which when executed by the processor, cause the processor to perform the computer-implemented method further comprising:
identifying a second available promotion based on a second correlation value of the plurality of correlation values;
generating the available promotion signal based on optimal available promotion and the second available promotion; and
transmitting the available promotion signal to a client device to cause display of information related to the optimal available promotion and the second available promotion on the user interface of the client device.

17-18. (canceled)

19. The computer program product of claim 18, wherein said generating the plurality of correlation values using a neural network that has been trained via reinforcement learning as the machine learning algorithm comprises generating the plurality of correlation values using the neural network that has been trained via reinforcement learning to evaluate at least one of an address, a number of purchases, a change in the number of purchases, an average number of purchases, a change in the average number of purchases, an amount of each purchase, a change in the amount of each purchase, an average amount of purchases, a change in the average amount of purchases, a frequency of purchases, a change in the frequency of purchases, and combinations thereof, of the customer data.

20. The computer program product of claim 15, wherein said identifying the optimal available promotion comprises identifying the optimal available promotion additionally based on at least one of a respective number of other customers associated with each of the respective plurality of promotion data and a respective time associated with each of the respective plurality of promotion data.
